(19) United States
(12) Patent Application Publication
(10) Pub. No.: US 2024/0340305 A1
(43) Pub. Date: Oct. 10, 2024

(54) PREVENTION OF ATTACKS VIA REQUESTED DISPLAYABLE CONTENT

(71) Applicants: George Mason University, Fairfax, VA (US); University of South Florida, Tampa, FL (US)

(72) Inventors: Mingkui Wei, Vienna, VA (US); Yao Liu, Tampa, FL (US); Zhuo Lu, Tampa, FL (US); Junjie Xiong, Tampa, FL (US)

(73) Assignees: George Mason University, Fairfax, VA (US); University of South Florida, Tampa, FL (US)

(21) Appl. No.: 18/623,565

(22) Filed: Apr. 1, 2024

Related U.S. Application Data
(60) Provisional application No. 63/456,827, filed on Apr. 4, 2023.

(51) Int. Cl. H04L 9/40; G06F 40/109

(52) U.S. Cl. CPC H04L 63/1441; G06F 40/109; H04L 63/1416

(57) ABSTRACT

A method and system disable executable script in requested displayable content. Responsive to requesting displayable content, a non-executable code sequence and a mis-matched font file that maps a plurality of characters of the requested displayable content to the non-executable code sequence is received. The non-executable code sequence is displayed as a text string in accordance with the received mis-matched font file.

### RELATED APPLICATIONS

This application claims the benefit of provisional application Ser. No. 63/456,827 filed Apr. 4, 2023 and titled “Using Mismatched Fonts to Prevent Web-Based Attacks,” the entire content of which is hereby incorporated by reference.

### GOVERNMENT RIGHTS

This invention was made with government support under grant number 2024300 awarded by the National Science Foundation. The government has certain rights in the invention.

### BRIEF DESCRIPTION OF THE DRAWINGS

The accompanying drawings provide visual representations which will be used to describe various representative embodiments more fully and can be used by those skilled in the art to understand better the representative embodiments disclosed and their inherent advantages. In these drawings, like reference numerals identify corresponding or analogous elements.

FIGS. 1 and 2 illustrate example method flows using mis-matched font files, in accordance with various embodiments of the present disclosure.

FIGS. 3 and 4 illustrate example method flows that depict the advantages of using mis-matched font files to safeguard against hidden executable code, in accordance with various embodiments of the present disclosure.

FIG. 5 illustrates an example controller and/or computing environment in which aspects of some of the embodiments of the present disclosure may be implemented, in accordance with embodiments of the present disclosure.

### DETAILED DESCRIPTION

Embodiments of the present disclosure will now be described with reference to the drawing figures, in which like reference numerals refer to like parts throughout.

### Combating Attacks via Requested Displayable Content

Web-based attacks, such as cross-site scripting (XSS) and cross-site request forgery (CSRF), are prevalent nowadays and extremely difficult to prevent. Although the result and impact differ, these types of web-based attacks share similar basic attack mechanisms, as will be described.

As a simple example, assume there is an online shopping website that displays a product in a webpage and allows any user to leave comments about this product. The comments are published on the webpage and can be viewed by anyone who visits this product page.

A normal user will leave comments that are written in plain language, such as “this product is good” or “this product is bad.” An attacker, however, will compose his comment as a piece of JavaScript, for example, “<script>alert ('hacked') </script>”. All the comments, benign and malicious, will be transferred to and stored by the web server. When the product page is visited by another user that is a requester (i.e., the victim), the victim's web browser will request the product page from the web server, which will send all the stored comments to the victim's web browser. The attack is triggered when the attacker's comment is received by the victim's web browser. Specifically, in the context of HTML, for example, <script> and </script> are used to respectively mark the beginning and end of a JavaScript program, which is not treated as displayable text content but is interpreted and executed by the victim's web browser. As a result, when the attacker's comment is received by the victim's browser, the browser recognizes the attacker's comment as an executable program, and consequently runs the program instead of displaying the requested content as text. In this example, the program alert (‘hacked’) merely pops up a window within the web browser and displays the word “hacked” to the victim but does not do anything harmful. However, the attacker can replace it with complicated JavaScript codes or other executable code to achieve malicious goals, such as stealing the victim's website cookies or executable script or code asking the victim's browser to send a request without the victim's awareness, for example.

Two options that may be used to address these types of web-based attacks fail to solve the problem. The first approach is user input validation. Using the example above, the web server will inspect each user's input (i.e., the comment sent by a user's web browser), and deny the input if the content is considered malicious. For instance, the attacker's comment “<script>alert ('hacked')</script>” will not be accepted by the web server because it contains prohibited keyword “<script>”. The second approach is character escaping. “Escape” in this context means replacing one character with another character or set of characters. There are standard encoding schemes that define how a character is escaped. For instance, with character escape, the string “<script>” will be replaced with “%3Cscript%3E” and then stored by the web server (the characters “<” and “>” are replaced by “% 3C” and “% 3E”, respectively). When a normal user visits the product page, the attacker's comment will be sent as the string “%3Cscript%3Ealert (‘hacked’) 3C%2Fscript%3E”. This string is not recognized as valid JavaScript; instead, it is translated by the browser into the text “<script>alert (‘hacked’)</script>” and displayed in the browser.

These countermeasures, however, are not effective because there are so many ways to embed a piece of JavaScript code or other executable code or script in a webpage; the use of “<script>” is not a necessary requirement, for instance. Attackers are always seeking innovative ways to bypass existing filters and have their codes run. Furthermore, the filters need to be manually enumerated and programmed by the programmer. It is difficult to enumerate all possible filters completely and comprehensively, and the programming itself is error-prone and often introduces more bugs than it solves.

The embodiments and teachings contained within this disclosure address these web-based attacks differently, by using purposefully created fonts with mismatched code and glyphs. To understand the improvements and advances discussed herein, first how fonts work is described.

With regard to Fonts

Letters, digits, and special characters, etc., displayed in a text-based document (such as a webpage) are encoded by encoding standards like the American Standard Code for Information Interchange (ASCII), which maps a character to a binary value. For example, the character “A” is encoded into “0×41” (the hexadecimal representation of the binary 100 0001) according to the ASCII. Based on the encoding standard, fonts have been created to display text with different appearances to accommodate functional and cosmetic needs. A font essentially defines three attributes of a set of characters: the glyphs (i.e., the appearance of characters, such as the images “A” or “A”), the codes (e.g., 0×41), and the mapping between the codes and the glyphs (e.g., the code 0×41 should be displayed using the glyph “A”).

The mapping of a font can be changed by editing a font file with font designing tools. For instance, any font that conforms to the ASCII standard maps the code 0×41 to the glyph “A”. The shape of the glyph may vary depending on the specific font. For example, Time New Roman displays 0×41 as the glyph of “A” while Arial Black displays it as the glyph of “A”. Both glyphs can be recognized as the letter “A” nonetheless. However, using ready-available tools, the font file can be edited and let the code 0×41 map to the glyph “B” or “C”, or any other glyphs. Essentially, when a computer reads the code 0×41, it will simply display the glyph that is specified by the font file in use, regardless if it is “A”, or “X”, or “2”, or any other characters.

### Using Mis-Matched Fonts to Prevent Attacks via Requested Displayable Content

Returning to the above example, what are being exchanged between the web server and web browser are codes instead of characters. As will be described, the embodiments described herein are not limited to web server and web browser. Specifically, for purposes of this example, however, when the attacker's comment is transferred to the web browser, it is the code sequence “3C 73 63 72 69 70 74 3E . . . ” that is received by the browser. According to the ASCII standard, the browser will interpret this code sequence into the text string “<script> . . . ”, recognize it as JavaScript, and then execute the program instead of displaying the text content.

As described herein, the disclosure provides for the use of a font file, referenced herein as a mis-matched font file, that is purposefully created and differs from the ASCII standard. For example, a new font file in which the characters “<s c r i p t>” maps to the code sequence “61 62 63 64 65 66 67 68” instead is created, generated or accessed. When this new code sequence is received by a web browser, it will interpret it as the string “a b c d e f g h” according to the ASCII standard, which is a normal text string (i.e., a string that cannot be interpreted as any valid executable code) and therefore will be displayed instead of executed. When the code sequence is displayed, the browser will look up the new font file to find the corresponding glyph of those codes, and consequently display the text string “<script>”.

As described above in the example, the root cause of such web-based attacks is that the attacker finds a way to hide a piece of executable JavaScript among a text string that is supposed to be displayed. When such a text string is received and processed by a web browser, the hidden script will be executed instead of displayed. This problem is overcome in accordance with the embodiments of the disclosure in which all characters of displayable content that are to be displayed are changed into a set of scrambled characters that do not exhibit any inherent meaning. As such, any hidden program will be rendered useless and will not be executed by the browser. On the other hand, the browser will still display the scrambled characters based on the specifically created mis-matched font file, which appears to be meaningful. This innovation essentially eradicates any possibility that a script that is hidden in a text string will be executed.

As recited in this disclosure, various embodiments provide a novel method and system to combat attacks using executable code or scripts that are hidden in requested displayable content.

The following embodiments are combinable.

Therefore, in one embodiment of the disclosure, an example method of disabling executable script in requested displayable content is provided: responsive to requesting displayable content, receiving a non-executable code sequence and a mis-matched font file that maps a plurality of characters of the requested displayable content to the non-executable code sequence; and displaying the non-executable code sequence as a text string in accordance with the received mis-matched font file.

In another embodiment of the method, generating the mis-matched font file that maps the plurality of characters of the requested displayable content to the non-executable code sequence.

In another embodiment of the method, a server selecting and providing the mis-matched font file to a browser that displays the non-executable code sequence as a text string in accordance with the received mis-matched font file.

In another embodiment of the method, the mis-matched font file is one of a plurality of mis-matched font files stored on one or more of a content server and a font server.

In another embodiment of the method, generating the mis-matched font file that maps the plurality of characters of the requested displayable content to the non-executable code sequence comprises generating for each character of the requested displayable content a mapping between an ASCII code and a glyph.

In another embodiment of the method, generating the mis-matched font file includes randomly mapping between the ASCII code and the glyph for each character of the requested displayable content in the mis-matched font file.

In another embodiment of the method, generating the mis-matched font file includes mapping between the ASCII code and the glyph according to a predetermined mapping scheme for each character of the requested displayable content in the mis-matched font file.

In another embodiment of the method, generating the mis-matched font file includes one or more of a font server and a content server determining a font-glyph mis-mapping of the mis-matched font file that maps the plurality of characters of the requested displayable content to the non-executable code sequence.

In another embodiment of the method, generating the mis-matched font file that maps the plurality of characters of the requested displayable content to the non-executable code sequence comprises generating for each character of the requested displayable content a mapping between an ASCII code and a glyph in accordance with the font-glyph mis-mapping.

In another embodiment of the method, requesting the requested displayable content.

In another embodiment of the method, responsive to requesting the requested displayable content, generating the mis-matched font file for each request and/or retrieving the mis-matched font file from a plurality of mis-matched font files stored on one or more of a content server and a font server.

In another embodiment of the method, generating the mis-matched font file for each request is performed by one or more of the content server and the font server.

In another embodiment of the method, further responsive to each new request for displayable content: receiving a new non-executable code sequence and a new mis-matched font file that maps the plurality of characters of the requested displayable content to the new non-executable code sequence; and displaying the non-executable code sequence as a text string in accordance with the new received mis-matched font file.

In one embodiment of the method, a method of disabling executable script in requested displayable content is provided: processing a plurality of characters of a requested displayable content to generate a non-executable code sequence and a mis-matched font file; and displaying the non-executable code sequence in accordance with the mis-matched font file.

In another embodiment of the method, further generating mis-matched font file that maps the plurality of characters of the requested displayable content to the non-executable code sequence.

In another embodiment of the method, generating the mis-matched font file that maps the plurality of characters of the requested displayable content to the non-executable code sequence comprises generating for each character of the requested displayable content a mapping between an ASCII code and a glyph in accordance with the font-glyph mis-mapping.

In another embodiment of the method, processing the plurality of characters of the requested displayable content to generate the non-executable code sequence and the mis-matched font file is performed by a server and displaying the non-executable code sequence in accordance with the mis-matched font file is performed by a browser.

In another embodiment of the method, requesting the requested displayable content by a browser.

generating by a server the mis-matched font file responsive to the browser requesting the requested displayable content.

In another embodiment of the method, with one or more of a content server and a font server generating the mis-matched font file responsive to the browser requesting the requested displayable content.

In another embodiment of the method, processing eradicates any executable script hidden within the requested displayable content.

### Example Flows for a Designed System

Example working flow charts of a system in accordance with various embodiments are illustrated in FIGS. 1-4. It is recognized that other implementations of the method and system described herein are contemplated; thus these examples are provided as not to limit the application of the described embodiments.

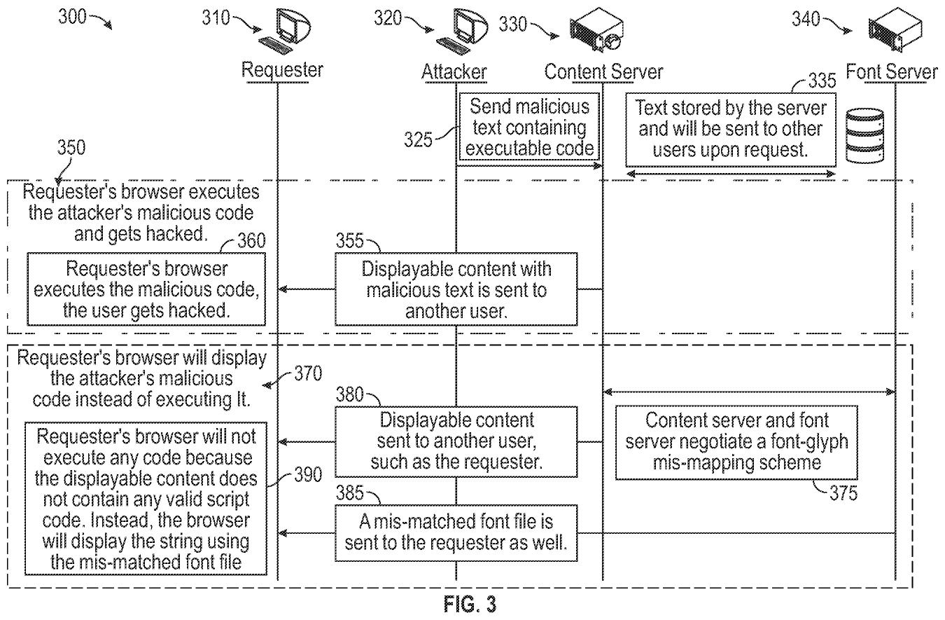

In the description of these drawings, reference is made to a Web server, a Font server and a Requestor. While a web server is shown and described as a server that provides web pages to be displayed in a browser to a user, it is also contemplated that the server may be a content server or a data server, as shown in FIG. 3, for example. Further, while a font server is shown and described as providing a mis-matched font file, it is understood that mis-matched font file(s) may be provided in response to a request from either the Font server, the Content server or the Web server.

The web server, or content or data server, may have already subscribed to a font service from the font server, which establishes a shared secret key between the Web server and the Font server in this example embodiment. A shared secret key between the web server and the Font server may otherwise be established as well.

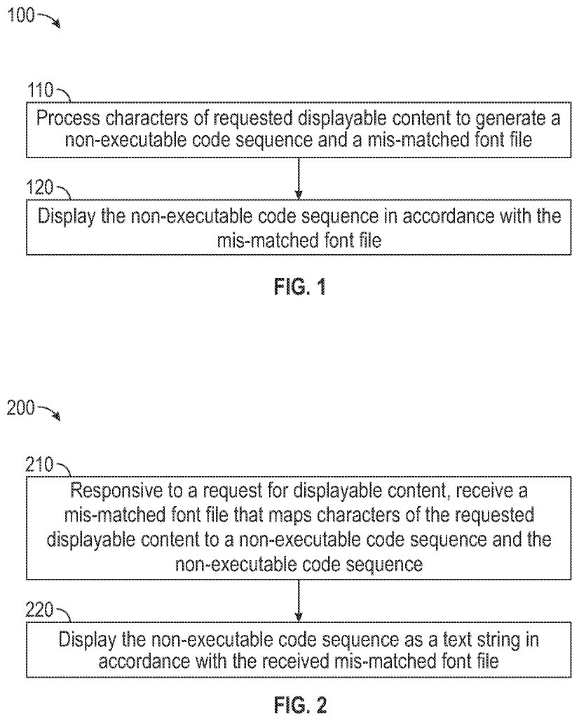

FIGS. 1 and 2 illustrate example method flows using mis-matched font files. Referring now to the example flow 100 of FIG. 1, a disclosed method provides in a broad sense that characters of requested displayable content are processed to generate a non-executable code sequence and a mis-matched font file at block 110.

At block 120, the non-executable code sequence is displayed in accordance with the mis-matched font file. The flow 200 of FIG. 2 provides that responsive to a request for displayable content, a mis-matched font file that maps characters of the requested displayable content to a non-executable code sequence and the non-executable code sequence are received, as shown in Block 210. At Block 220, the non-executable code sequence is displayed as a text string in accordance with the received mis-matched font file.

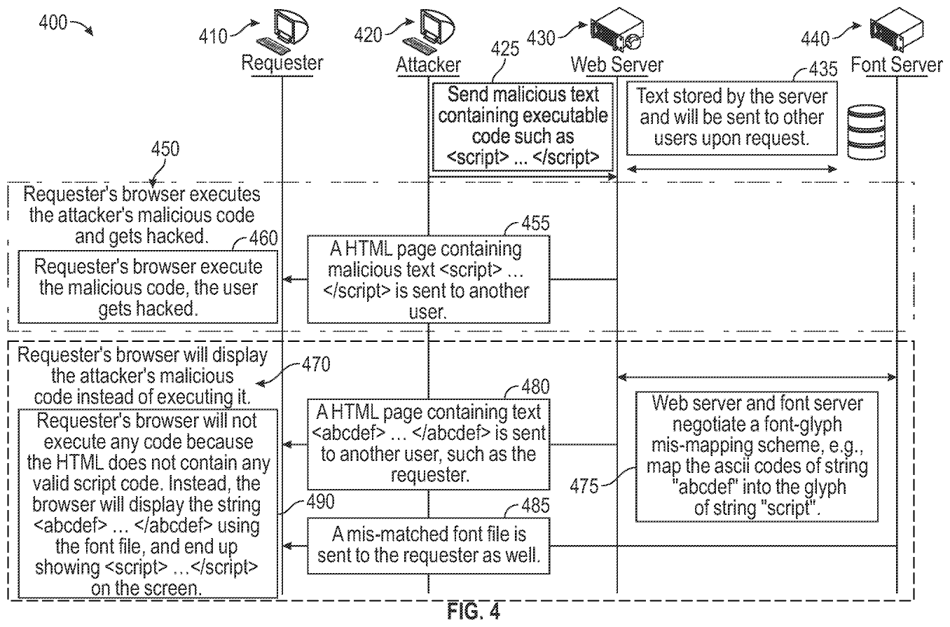

FIGS. 3 and 4 illustrate example method flows that depict the advantages of using mis-matched font files to safeguard against hidden executable code, in accordance with various embodiments of the present disclosure. Referring now to FIG. 3, example flow 300 of a system having a Requester 310 (user), Attacker 320, Content Server 330 and Font Server 340 in communication on a network is shown. The Content Server 330 and the Font Server 340 and their respective functionalities may reside on the same or separate servers or server portions. The Font Server supplies a font file to the Requester and in accordance with various embodiments a set of mis-matched font files can be pre-created and placed on the Content Server, which will allow the Content Server to choose a mis-matched font file and send it to the Requester. Moreover, the mis-matched font file can be generated either randomly or in a deterministic way. In an example of random generation, the mis-matched font file can be created by randomly generating a map between an ASCII code and a glyph, which may result in, for example, letting the ASCII of “a” using the glyph of “d”, and the ASCII of “b” using the glyph of “<”, etc. An example of deterministic generation would include shifting one position according to all the characters' order in the ASCII table. That is, let the ASCII of “a” using the glyph of “b”, the ASCII of “b” using the glyph of “c”, and the ASCII of “c” using the glyph of “d”, etc.

As previously described, Content Server may be a Web server as shown in FIG. 4 but it need not be Web-based. For example, a HTML file may be created locally on a computer and sent as an e-mail attachment. Any requested displayable content, including an e-mail attachment, may pose a risk, harboring hidden executable code. While the displayable requested content may be an HTML document, it may be any document type that can be opened in a browser used by Requester 310. Such a document may contain malicious code that may be executed when opened in a browser; use of the mis-matched font file protects the Requester from an attack brought on by executable content, such as a script or other code, that may be hiding within requested displayable content. For instance, applications using HTML5 technology display HTML-like markup code and does not necessarily interact with a web server. Further, within the example shown in FIG. 3, a browser is not limited to the traditional concept of a Chrome or Safari browser used on the Internet. Many applications, especially smart phone applications, have built-in capabilities that can act as a browser, able to interact with a Web Server and open Web pages, for example.

In Block 350, this flow that does not use mis-match font files and so Requester 310 is at risk of hidden executable code, scripts within requested displayable content that it might request using the Requester's Browser. Attacker 320 may send malicious text containing executable code at 325. At block 335 this text may be stored by the Content server 330 in a database as shown or otherwise. The stored text may be sent to others, including Requester 310, upon request 355. Once received, the Requester's browser may execute the malicious code with the result that the Requester is hacked, at 360.

Contrast this negative outcome with the flow of Block 370 in which the Requester's browser will display the attacker's malicious code instead of executing it. The Attacker 320 still sends malicious text containing executable code at 325. However, in flow 370, the content server and the font server 330, 340 together negotiate a font-glyph mis-mapping scheme at 375 and will return to the Requester two items: the requested displayable content 380, a non-executable code sequence, and a mis-matched font file 385. The Requester's browser doesn't execute any malicious code because the displayable content does not contain any valid script code. Rather, the Requester's browser displays the returned non-executable code string according to the mis-matched font file at 390.

Referring now to FIG. 4, flow 400 of a system having a Requester 410, an Attacker 420, a Web Server 430 and a Font Server 440 in communication on a network is shown. The Web Server 430 and the Font Server 440 and their respective functionalities may reside on the same or separate servers or server portions. The flow in Block 450 illustrates the risk of hidden executable code while the flow in Block 470 illustrates how the use of a mis-match font file mitigates the hidden malicious code problem and simply displays the attacker's malicious code instead of executing it.

At Block 425 the Attacker 420 sends malicious text containing executable code, such as “<script> . . . </script>” stored at 440. At block 455, an HTML page containing the malicious text “<script> . . . </script>” is available at 435 from the Web server to be sent to a requester, such as Requester 410. When the Requester's browser receives this, it may execute the malicious text and is hacked at 460.

Contrast this with the flow of 470. The Web and font servers 430, 440 negotiate a font-glyph mis-mapping (mis-matching) schedule, e.g. map the ASCII codes of string “abcdef” into the glyph of string “script.” At 475. Upon a request from the browser of Requester 410, the Web Server returns two things: an HTML page containing text string “<abcdef> . . . “</abcdef>” at 480 and a mis-matched font file at 485. At 490, the Requester's browser will not execute any code because the HTML does not contain any valid script code Instead, the browser will display the string “<abcdef> . . . “</abcdef>” using the mis-matched font file and end up showing (displaying) “<script> . . . </script>” on the screen or other display means.

The embodiments disclosed herein leverage mis-matched codes and glyphs of a font and thereby provide a novel method and system to combat attacks using executable code or scripts that are hidden in requested displayable content. So long as the Attacker does not know the font-glyph mapping when crafting malicious code, the solutions presented herein are effective. To safeguard against an attacker knowing the mapping, the content or web server can choose to use different font-glyph mappings to serve each request, which essentially eliminates the possibility that an attacker can craft any malicious codes beforehand. In accordance with this approach, responsive to requesting displayable content, a mis-matched font file can be generated for each request; this may be performed by one or both of the content server and the font server.

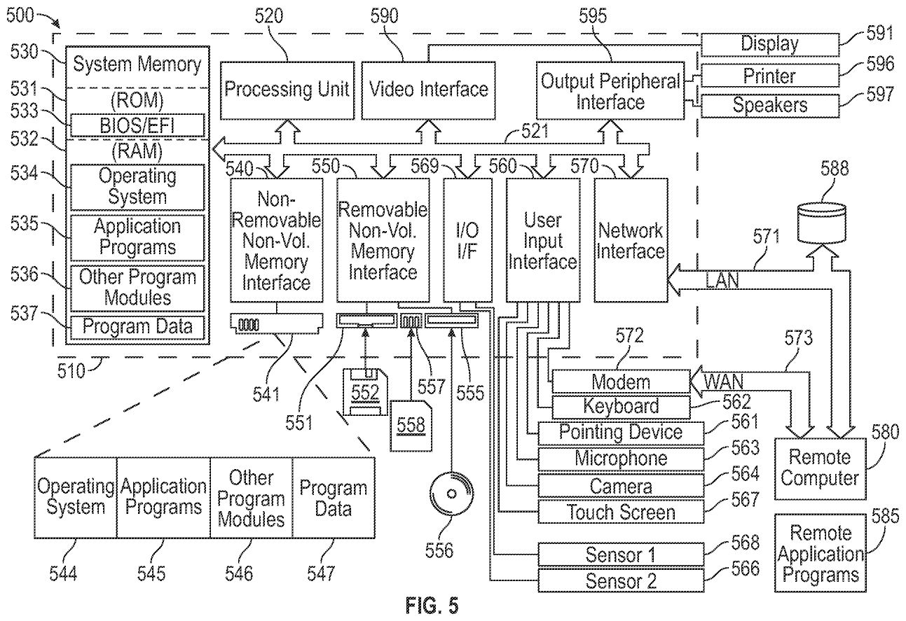

FIG. 5 illustrates an example controller and/or computing environment on which aspects of some embodiments may be implemented. The computing environment 500 is only one example of a computing environment and is not intended to suggest any limitation as to the scope of use or functionality of the claimed subject matter. Neither should the computing environment 500 be interpreted as having any dependency or requirement relating to any one or combination of components illustrated in the example operating environment 500.

Embodiments are operational with numerous other general purpose or special purpose computing system environments or configurations. Examples of well-known computing systems, environments, and/or configurations that may be suitable for use with various embodiments include, but are not limited to, embedded computing systems, personal computers, server computers, mobile devices, hand-held or laptop devices, multiprocessor systems, microprocessor-based systems, set top boxes, programmable consumer electronics, medical device, network PCs, minicomputers, mainframe computers, cloud services, telephonic systems, distributed computing environments that include any of the above systems or devices, and the like.

Embodiments may be described in the general context of computer executable instructions, such as program modules, being executed by computing capable devices. Generally, program modules include routines, programs, objects, components, data structures, etc. that perform particular tasks or implement particular abstract data types. Some embodiments may be designed to be practiced in distributed computing environments where tasks are performed by remote processing devices that are linked through a communications network. In a distributed computing environment, program modules may be located in both local and remote computer storage media including memory storage devices.

With reference to FIG. 5, an example system for implementing some embodiments includes a computing device 510. Components of computing device 510 may include, but are not limited to, a processing unit 520, a system memory 530, and a system bus 521 that couples various system components including the system memory to the processing unit 520.

Computing device 510 may comprise a variety of computer readable media. Computer readable media may be any available media that can be accessed by computing device 510 and includes both volatile and nonvolatile media, and removable and non-removable media. By way of example, and not limitation, computer readable media may comprise computer storage media and communication media. Computer storage media may comprise volatile and/or nonvolatile, and/or removable and/or non-removable media implemented in any method or technology for storage of information such as computer readable instructions, data structures, program modules or other data. Computer storage media comprises, but is not limited to, random access memory (RAM), read-only memory (ROM), electrically erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by computing device 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media configured to communicate modulated data signal(s). Combinations of any of the above should also be included within the scope of computer readable media.

System memory 530 includes computer storage media in the form of volatile and/or nonvolatile memory such as ROM 531 and RAM 532. A basic input/output system 533 (BIOS), containing the basic routines that help to transfer information between elements within computing device 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537 that may be stored in RAM 532.

Computing device 510 may also include other removable/non-removable volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, a flash drive reader 557 that reads flash drive 558, and an optical disk drive 555 that reads from or writes to a removable, nonvolatile optical disk 556 such as a Compact Disc Read Only Memory (CD ROM), Digital Versatile Disc (DVD), Blue-ray Disc™ (BD) or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5 provide storage of computer readable instructions, data structures, program modules and other data for computing device 510. In FIG. 5, for example, hard disk drive 541 is illustrated as storing operating system 544, application programs 545, program data 547, and other program modules 546. Additionally, for example, non-volatile memory may include instructions, for example, to discover and configure IT device(s); to create device neutral user interface command(s); combinations thereof, and/or the like.

A user may enter commands and information into computing device 510 through input devices such as a keyboard 562, a microphone 563, a camera 564, touch screen 567, and a pointing device 561, such as a mouse, trackball or touch pad. These and other input devices are often connected to the processing unit 520 through a user input interface 560 that is coupled to the system bus, but may be connected by other interface and bus structures, such as a parallel port, a game port and/or a universal serial bus (USB).

Sensors, such as sensor 1 568 and sensor 2 56, may be connected to the system bus 521 via an Input/Output Interface (I/O I/F) 569. Examples of sensor(s) 566, 568 include a microphone, an accelerometer, an inertial navigation unit, a piezoelectric crystal, and/or the like. A monitor 591 or other type of display device may also be connected to the system bus 521 via an interface, such as a video interface 590. Other devices, such as, for example, speakers 597 and printer 596 may be connected to the system via peripheral interface 595.

Computing device 510 may be operated in a networked environment using logical connections to one or more remote computers, such as a remote computer 580. The remote computer 580 may be a personal computer, a mobile device, a hand-held device, a server, a router, a network PC, a medical device, a peer device or other common network node, and typically includes many or all of the elements described above relative to computing device 510. The logical connections depicted in FIG. 5 include a local area network (LAN) 571 and a wide area network (WAN) 573, but may also include other networks such as, for example, a cellular network. Such networking environments are commonplace in offices, enterprise-wide computer networks, intranets and the Internet.

When used in a LAN networking environment, computing device 510 may be connected to the LAN 571 through a network interface or adapter 570. When used in a WAN networking environment, computing device 510 typically includes a modem 572 or other means for establishing communications over the WAN 573, such as the Internet. The modem 572, which may be internal or external, may be connected to the system bus 521 via the user input interface 560, or other appropriate mechanism. The modem 572 may be wired or wireless. Examples of wireless devices may comprise, but are limited to: Wi-Fi, Near-field Communication (NFC) and Bluetooth™. In a networked environment, program modules depicted relative to computing device 510, or portions thereof, may be stored in the remote memory storage device 588. By way of example, and not limitation, FIG. 5 illustrates remote application programs 585 as residing on remote computer 580. It will be appreciated that the network connections shown are exemplary and other means of establishing a communications link between the computers may be used.

Additionally, for example, LAN 571 and WAN 573 may provide a network interface to communicate with other distributed infrastructure management device(s); with IT device(s); with users remotely accessing the User Input Interface 560; combinations thereof, and/or the like.

While implementations of the disclosure are susceptible to embodiment in many different forms, there is shown in the drawings and will herein be described in detail specific embodiments, with the understanding that the present disclosure is to be considered as an example of the principles of the disclosure and not intended to limit the disclosure to the specific embodiments shown and described. In the description above, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” “for example,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus, device, system, etc. may be used interchangeably in this text.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A method of disabling executable script in requested displayable content, comprising:
responsive to requesting displayable content, receiving a non-executable code sequence and a mis-matched font file that maps a plurality of characters of the requested displayable content to the non-executable code sequence; and
displaying the non-executable code sequence as a text string in accordance with the received mis-matched font file.

2. The method of claim 1, further comprising generating the mis-matched font file that maps the plurality of characters of the requested displayable content to the non-executable code sequence.

3. The method of claim 2, with a server selecting and providing the mis-matched font file to a browser that displays the non-executable code sequence as a text string in accordance with the received mis-matched font file.

4. The method of claim 3, where the mis-matched font file is one of a plurality of mis-matched font files stored on one or more of a content server and a font server.

5. The method claim 2, where generating the mis-matched font file that maps the plurality of characters of the requested displayable content to the non-executable code sequence comprises generating for each character of the requested displayable content a mapping between an ASCII code and a glyph.

6. The method of claim 5, where generating the mis-matched font file includes randomly mapping between the ASCII code and the glyph for each character of the requested displayable content in the mis-matched font file.

7. The method of claim 5, where generating the mis-matched font file includes mapping between the ASCII code and the glyph according to a predetermined mapping scheme for each character of the requested displayable content in the mis-matched font file.

8. The method of claim 2, where generating the mis-matched font file includes one or more of a font server and a content server determining a font-glyph mis-mapping of the mis-matched font file that maps the plurality of characters of the requested displayable content to the non-executable code sequence.

9. The method of claim 8, where generating the mis-matched font file that maps the plurality of characters of the requested displayable content to the non-executable code sequence comprises generating for each character of the requested displayable content a mapping between an ASCII code and a glyph in accordance with the font-glyph mis-mapping.

10. The method of claim 1, further comprising requesting the requested displayable content.

11. The method of claim 10, where responsive to requesting the requested displayable content, one or more of:
generating the mis-matched font file for each request; and
retrieving the mis-matched font file from a plurality of mis-matched font files stored on one or more of a content server and a font server.

12. The method of claim 11, where generating the mis-matched font file for each request is performed by one or more of the content server and the font server.

13. The method of claim 1, further comprising responsive to each new request for displayable content:
receiving a new non-executable code sequence and a new mis-matched font file that maps the plurality of characters of the requested displayable content to the new non-executable code sequence; and
displaying the non-executable code sequence as a text string in accordance with the new received mis-matched font file.

14. A method of disabling executable script in requested displayable content, comprising:
processing a plurality of characters of a requested displayable content to generate a non-executable code sequence and a mis-matched font file; and
displaying the non-executable code sequence in accordance with the mis-matched font file.

15. The method of claim 14, further comprising generating mis-matched font file that maps the plurality of characters of the requested displayable content to the non-executable code sequence.

16. The method of claim 15, where generating the mis-matched font file that maps the plurality of characters of the requested displayable content to the non-executable code sequence comprises generating for each character of the requested displayable content a mapping between an ASCII code and a glyph in accordance with the font-glyph mis-mapping.

17. The method of claim 14, where processing the plurality of characters of the requested displayable content to generate the non-executable code sequence and the mis-matched font file is performed by a server and displaying the non-executable code sequence in accordance with the mis-matched font file is performed by a browser.

18. The method of claim 17, further comprising requesting the requested displayable content by the browser and generating by a server the mis-matched font file responsive to the browser requesting the requested displayable content.

19. The method of claim 17, further comprising requesting the requested displayable content by the browser with one or more of a content server and a font server and generating the mis-matched font file responsive to the browser requesting the requested displayable content.

20. The method of claim 14, where the processing eradicates any executable script hidden within the requested displayable content.
